(19) United States
(12) Patent Application Publication
(10) Pub. No.: US 2017/0329767 A1
(43) Pub. Date: Nov. 16, 2017

(54) LOCALIZATION OF APPLICATION USER INTERFACE

(71) Applicant: International Business Machines Corporation, Armonk, NY (US)

(72) Inventors: Hui-Ying Liu, Taipei City (TW); Yi-Lin Tsai, Taichung City (TW); Der-Joung Wang, New Taipei City (TW); Yen-Min Wu, Taipei City (TW)

(21) Appl. No.: 15/151,262

(22) Filed: May 10, 2016

(51) Int. Cl. G06F 17/28; G06F 17/22

(52) U.S. Cl. CPC G06F 17/28; G06F 17/2247

(57) ABSTRACT

A computer identifies, within a portion of code, a code element associated with a label. The computer identifies an x-path corresponding to a value associated with the label. The computer transmits a request to translate the value. The computer receives a translated version of the value associated with the label. The computer utilizes the identified x-path to locate the value associated with the label within the portion of code. The computer updates the portion of code by replacing the value associated with the label with the translated version of the value.

### TECHNICAL FIELD

The present invention relates to an application user interface, and more particularly to the localization of an application user interface.

### BACKGROUND

In the digital age, a user interface corresponding to an application may be viewed and utilized by people from all over the world. Therefore, there is a need for the content displayed by the user interface to be understandable by a variety of people who speak a variety of languages. Localization is the process of customizing an application, webpage, or website for a given culture or locale. For example, localization of a user interface may consist of providing of user interface or an application that abides by the customs and traditions of a certain culture.

### SUMMARY

The present invention provides a method, system, and computer program product for localizing a user interface, in accordance to an embodiment of the invention. A computer identifies, within a portion of code, a code element associated with a label. The computer identifies an x-path corresponding to a value associated with the label. The computer transmits a request to translate the value. The computer receives a translated version of the value associated with the label. The computer utilizes the identified x-path to locate the value associated with the label within the portion of code. The computer updates the portion of code by replacing the value associated with the label with the translated version of the value.

### BRIEF DESCRIPTION OF THE DRAWINGS

FIG. 1 illustrates a localization system, in accordance with an embodiment of the invention.

FIG. 2 is a flowchart illustrating the operations of the translation program of FIG. 1, in accordance with an embodiment of the invention.

FIG. 3 depicts an illustration of a portion of code corresponding to a graphical user interface, in accordance with an embodiment of the invention.

FIG. 4 depicts an illustration of a portion of code corresponding to a graphical user interface, in accordance with an embodiment of the invention.

FIG. 5 is a block diagram depicting the hardware components of the localization system of FIG. 1, in accordance with an embodiment of the invention.

### DETAILED DESCRIPTION

Embodiments of the present invention will now be described in detail with reference to the accompanying Figures.

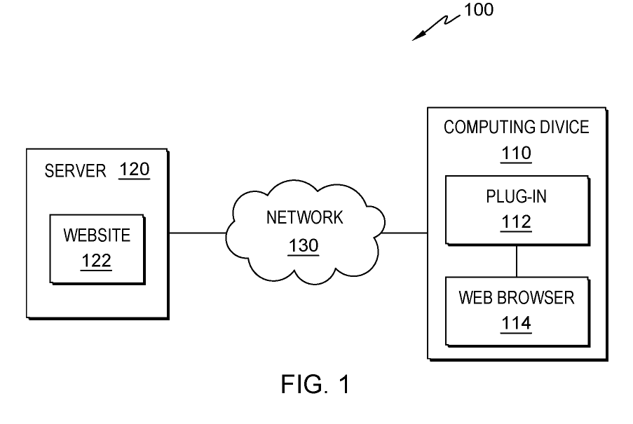

FIG. 1 illustrates localization system 100, in accordance with an embodiment of the invention. In an exemplary embodiment, localization system 100 includes computing device 110 and server 120 interconnected via network 130.

In the exemplary embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between computing device 110 and server 120.

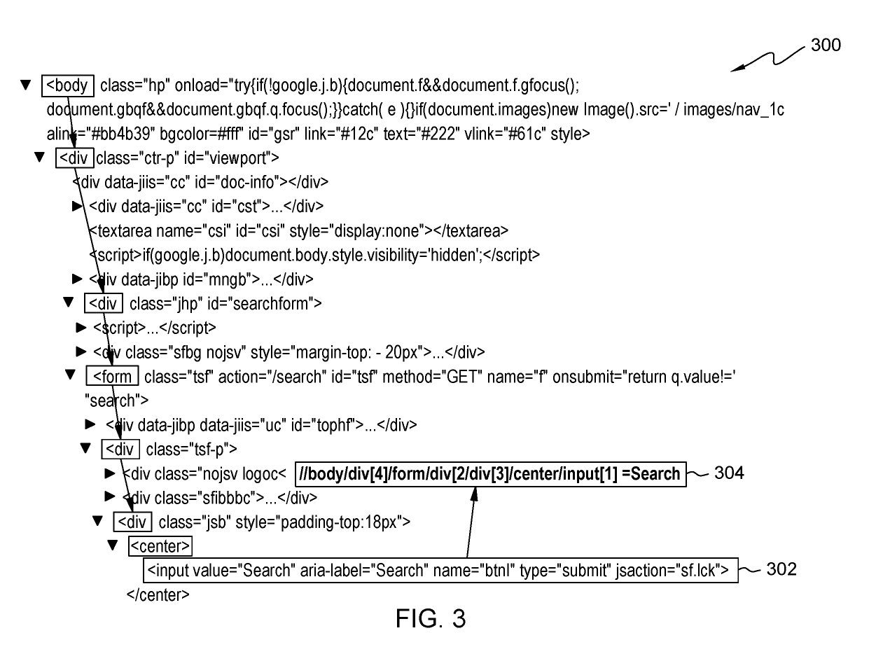

Server 120 includes website 122. Server 120 may be a desktop computer, a notebook, a laptop computer, a tablet computer, a handheld device, a smart-phone, a thin client, or any other electronic device or computing system capable of receiving and sending data to and from other computing devices, such as computing device 110, via network 130. Although not shown, optionally, server 120 can comprise a cluster of servers executing the same software to collectively process requests as distributed by a front end server and a load balancer. Server 120 is described in more detail with reference to FIG. 3.

Website 122 is a collection of files including, for example, hypertext markup language (HTML) files, Cascading Style Sheets (CSS) files, image files and JavaScript files. Website 122 can also include other resources such as audio files and video files.

In the example embodiment, computing device 110 is a computing device capable of receiving and sending data to and from other computing devices, such as server 120, via a network, such as network 130. For example, a computing device 110 may include a tablet computer, a smart watch, smart glasses, a handheld device, a smart-phone, a thin client, or an alternative portable device. Computing device 110 is described in more detail with reference to FIG. 3.

Web browser 114 is a program that enables users to view, watch, or listen to documents and other resources, such as audio and video files, retrieved from a network device. In an exemplary embodiment, web browser 114 requests documents and other resources, identified by their URL, from server 120 via network 130. Web browser 114 transmits requests to server 120 for documents and/or resources contained in website 122. Server 120 responds to the requests by retrieving the documents and resources from website 122, and transmitting them back to web browser 114 via network 130. In an exemplary embodiment, documents and resources retrieved by web browser 114 are viewed by a user of computing device 110 on a display device. In general, web browser 114 can be any browser application capable of execution on a computing device, and capable of supporting plug-in 112.

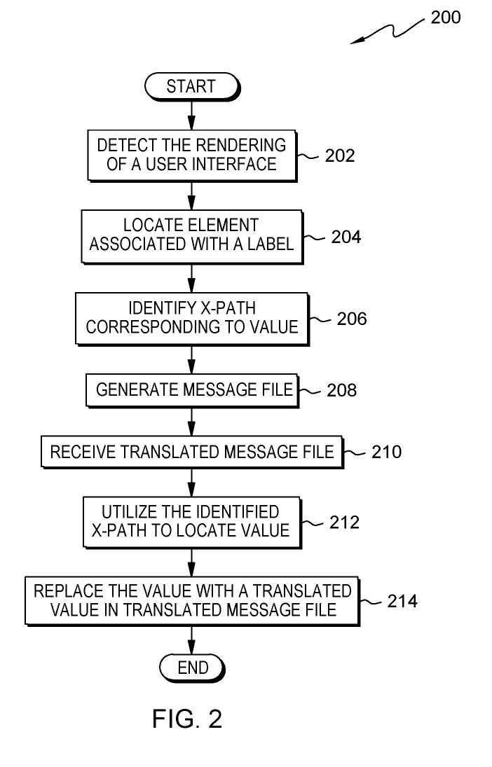

In the example embodiment plug-in 112 is capable of detecting when web browser 114 is opened (when a user interface is rendered), for example, by being partially or fully integrated with web browser 114. In other embodiments, plug-in 112 is a stand-alone program. In addition, plug-in 112 is capable of reading code, such as XML code, corresponding to the rendered user interface, and determining an element within the code corresponding to a label. Furthermore, plug-in 112 is capable of determining an x-path corresponding to a value associated with the label. Plug-in 112 is further capable of replacing the value associated with the label with a translated value. Plug-in 112 is described in further detail below with reference to FIG. 2.

FIG. 2 is a flowchart illustrating the operations of plug-in 112 in rendering a translated user interface, in accordance with an embodiment of the invention. In the example embodiment, plug-in 112 detects that a user interface has been rendered via web browser 114 (step 202). In other embodiments, the user interface may be rendered by another application. For example, plug-in 112 may detect that a homepage of web browser 114 has been rendered. As stated above, in the example embodiment, plug-in 112 is integrated with web browser 114, and therefore, is capable of directly detecting when a user interface is rendered by web browser 114 (or detecting when web browser 114 is opened). In other embodiments, where plug-in 112 is not integrated with web browser 114, plug-in 112 may communicate with the operating system of computing device 110 in order to determine that a user interface has been rendered.

In the example embodiment, plug-in 112 reads through the XML code, such as HTML code, corresponding to the rendered user interface (such as web page) and locates an element associated with a “label” (step 204). A “label”, within the context of XML code, corresponds to information that is displayed on the user interface to the user. Therefore, by locating elements that correspond to a “label”, plug-in 112 is able to determine the portions of XML code that detail what is displayed on the user interface. For example, a search engine may have the following XML code (or in this case, HTML code) associated with a label in order to describe a “search button” depicted on the search engine webpage: “<input value=“Search” aria-label=“Search” name=“btnK” type=“submit” jsaction=“sf.chk”>”. As shown, the term “Search” is the value associated with the label, and therefore, will be displayed to the user viewing the search engine webpage (i.e., a search button on a search engine webpage). In this example, plug-in 112 reads through the HTML code corresponding to the search engine webpage and identifies this portion of HTML code as being associated with a “label”.

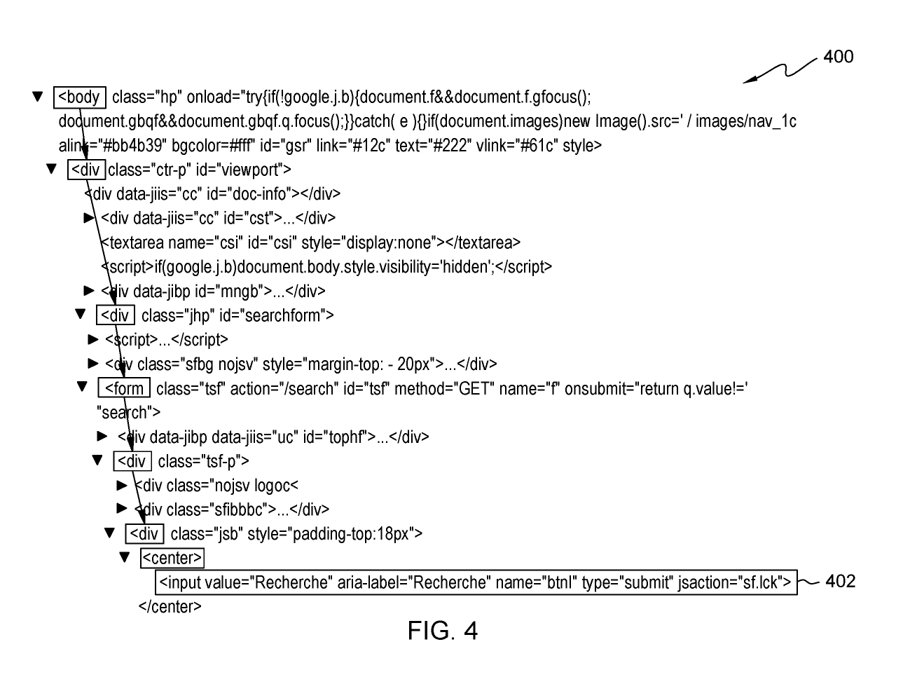

Plug-in 112 determines an x-path corresponding to a value associated with the label (step 206). In the example embodiment, an x-path, within the context of XML code, is a key that allows a program to locate a specific value. For example, the x-path associated with the label may be “//body/div[4]/form/div[2]/div[3]/center/input[1]=Search”. The x-path can be used as a roadmap to locate a specific value, in this case “Search”, within the XML code. The methodology of determining an x-path is detailed further in FIG. 3 and FIG. 4.

Plug-in 112 generates a message file with the message file including the x-path (step 208). In the example embodiment, plug-in 112 then transmits the message file to a translation center so that the value can be translated to the target language. For example, if the user defined target language is French, plug-in 112 transmits the message file to a translation center capable of translating between the English and French languages. After translation, plug-in 112 then receives the translated message file (step 210). In another embodiment, plug-in 112 may also determine the target language for computing device 110 by way of communicating with the operating system of computing device 110. In further embodiments, plug-in 112 may determine the target language associated with computing device 110 (or a specific user of computing device 110) by referencing preferences associated with web browser 114 or preferences associated with another application on computing device 110.

Plug-in 112 utilizes the x-path information located in the translated message file to locate the value to be translated (step 212). As stated above, an x-path can serve as a roadmap to finding a specific value within XML code. The x-path details a series of nodes which can be followed to a value. As stated above, the methodology of determining and the contents of an x-path are discussed in further detail in FIG. 3. Referring to the example above, plug-in 112 utilizes the x-path in the translated message file to locate the value “Search” within the HTML code corresponding to the search engine webpage.

Plug-in 112 replaces the value in the XML code with the translated value present in the translated message file (step 214). Referring to the example above, where the target language is French, plug-in 112 references the translated message file to determine the translated value of “Search”, “Recherche”, and replaces the value “Search” in the HTML code with the translated value “Recherche”. In the example embodiment, plug-in 112 replaces the value while preserving the rest of the HTML code associated with the value (including the node names, attribute names, and non-translation related attribute values). In other embodiments, plug-in 112 replaces the entire portion of HTML code associated with the value (the portion shown in step 206, for example). After the replacement has been completed, the webpage is rendered with the translated value “Recherche” displayed to the user in lieu of “Search”.

In other embodiments, plug-in 112 may perform the steps referenced above in order to rendering a translated user interface for a graphical user interface created from utilizing a coding language that is not XML based (such as Java). In this other embodiment, plug-in 112 transforms the graphical user interface into a tree graph representation. In one embodiment, an inspection tool may be utilized to view the layout and labels associated with a selected element of a graphical user interface. Plug-in 112 then transforms the tree graph into an XML format and proceeds with the steps referenced above beginning with step 204.

FIG. 3 depicts an illustration of a portion of code corresponding to a graphical user interface, in accordance with an embodiment of the invention. In the example embodiment, code 300 is a portion of code corresponding to a graphical user interface. For example, the portion of code may correspond to a search engine graphical interface presenting a “search button”. Portion of code 302 corresponds to a portion of code that is associated with a “label”. In this example, the “label” or “value” associated with the label is “Search”, which represents the value displayed on the “search button” presented on the search engine graphical user interface. X-path 304 is the x-path corresponding to the “value”. As stated above, an x-path provides a roadmap to locate a specific value, in this case “Search”. Plug-in 112 identifies the x-path so that it may be utilized later in locating the value “Search”.

FIG. 4 depicts an illustration of a portion of code corresponding to a graphical user interface, in accordance with an embodiment of the invention. In the example embodiment, code 400 represents the portion of code presented in FIG. 3 after plug-in 112 has replaced the “value” associated with the x-path with the translated value. In this example embodiment, portion of code 402 represents the portion of code that is associated with the “label”. In this example embodiment, plug-in has replaced the value “Search” with the translated value “Recherche”. Therefore, when rendered, the graphical user interface corresponding to code 400 displays a search button with the translated value “Recherche” displayed on the search button.

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

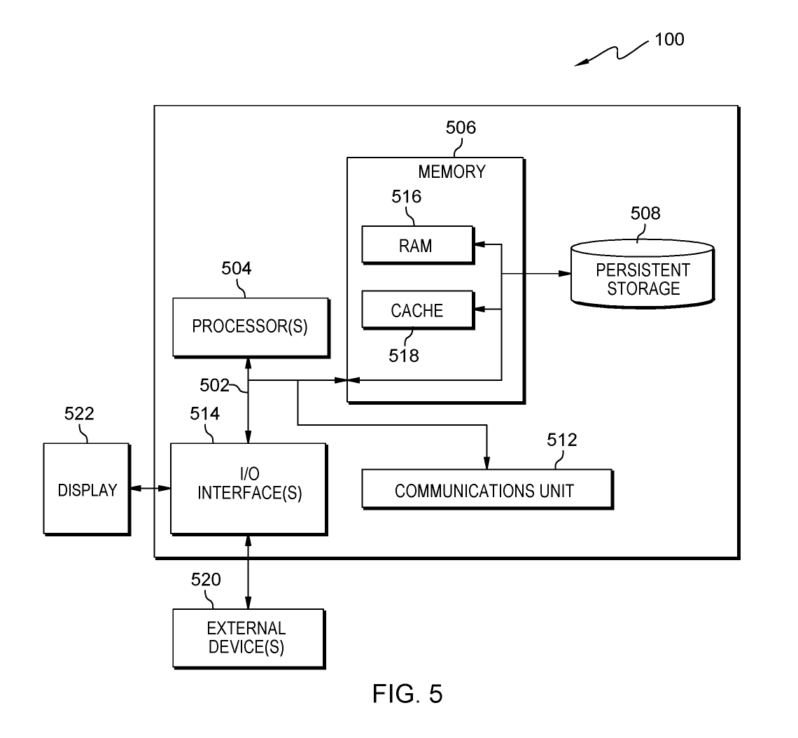

FIG. 5 depicts a block diagram of components of computing device 110, and server 120 of a localization system 100 of FIG. 1, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

Computing device 110 and server 120 include respective communications fabric 502, which provides communications between computer processor(s) 504, memory 506, persistent storage 508, communications unit 512, and input/output (I/O) interface(s) 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 516 and cache memory 518. In general, memory 506 can include any suitable volatile or non-volatile computer-readable storage media.

The programs plug-in 112, web browser 114 stored in computing device 110 and website 122 stored in server 120 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links. The programs plug-in 112, web browser 114 stored in computing device 110, and website 122 stored in server 120 may be downloaded to persistent storage 508 through communications unit 512.

I/O interface(s) 514 allows for input and output of data with other devices that may be connected to computing device 110 and server 120. For example, I/O interface 514 may provide a connection to external devices 520 such as a keyboard, keypad, a touch screen, and/or some other suitable input device. External devices 520 can also include portable computer-readable storage media such as, for example, thumb drives, portable optical or magnetic disks, and memory cards. Software and data used to practice embodiments of the present invention, e.g., programs plug-in 112, web browser 114 stored in computing device 110, and website 122 stored in server 120, can be stored on such portable computer-readable storage media and can be loaded onto persistent storage 508 via I/O interface(s) 514. I/O interface(s) 514 can also connect to a display 522.

Display 522 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
a computer identifying, within a portion of code, a code element associated with a label, the code being stored on a computer readable medium;
the computer identifying an x-path corresponding to a value associated with the label;
the computer transmitting a request to translate the value associated with the label;
the computer receiving a translated version of the value associated with the label;
the computer utilizing the identified x-path to locate the value associated with the label within the portion of code; and
the computer updating the portion of code by replacing the value associated with the label with the translated version of the value.

2. The method of claim 1, further comprising the computer rendering a user interface corresponding to the update portion of code.

3. The method of claim 1, wherein the computer identifying, within a portion of code, a code element associated with a label is performed in response to the computer detecting a rendering of a user interface corresponding to the portion of code.

4. The method of claim 1, further comprising the computer determining a target language associated with a user of the computer.

5. The method of claim 4, wherein the computer determining a target language associated with a user of the computer further comprises referencing preferences associated with one or more applications of the computer.

6. The method of claim 1, wherein the portion of code is in XML format.

7. The method of claim 1, further comprising the computer transforming a user interface associated with the portion of code to a tree graph, and the computer transforming the tree graph into a portion of code that is in XML format.

8. A computer program product comprising:
one or more computer-readable storage devices and program instructions stored on at least one of the one or more tangible storage devices, the program instructions comprising:
program instruction to identify, within a portion of code, a code element associated with a label;
program instructions to identify an x-path corresponding to a value associated with the label;
program instructions to transmit a request to translate the value associated with the label;
program instructions to receive a translated version of the value associated with the label;
program instructions to utilize the identified x-path to locate the value associated with the label within the portion of code; and
program instructions to update the portion of code by replacing the value associated with the label with the translated version of the value.

9. The computer program product of claim 8, further comprising program instructions to render a user interface corresponding to the updated portion of code.

10. The computer program product of claim 8, further comprising program instructions to detect a rendering of a user interface corresponding to the portion of code.

11. The computer program product of claim 8, further comprising program instructions to determine a target language associated with a user of a computer.

12. The computer program product of claim 11, wherein the program instructions to determine a target language associated with a user of a computer further comprises program instructions to reference preferences associated with one or more applications of the computer.

13. The computer program product of claim 8, wherein the portion of code is in XML format.

14. The computer program product of claim 8, further comprising program instructions to transform a user interface associated with the portion of code to a tree graph, and program instructions to transform the tree graph into a portion of code that is in XML format.

15. A computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instruction to identify, within a portion of code, a code element associated with a label;
program instructions to identify an x-path corresponding to a value associated with the label;
program instructions to transmit a request to translate the value associated with the label;
program instructions to receive a translated version of the value associated with the label;
program instructions to utilize the identified x-path to locate the value associated with the label within the portion of code; and
program instructions to update the portion of code by replacing the value associated with the label with the translated version of the value.

16. The computer system of claim 15, further comprising program instructions to render a user interface corresponding to the updated portion of code.

17. The computer system of claim 15, further comprising program instructions to determine a target language associated with a user of a computer.

18. The computer system of claim 17, wherein the program instructions to determine a target language associated with a user of a computer further comprises program instructions to reference preferences associated with one or more applications of the computer.

19. The computer system of claim 15, wherein the portion of code is in XML format.

20. The computer system of claim 15, further comprising program instructions to transform a user interface associated with the portion of code to a tree graph, and program instructions to transform the tree graph into a portion of code that is in XML format.
